(19) United States
(12) Patent Application Publication
(10) Pub. No.: US 2006/0050043 A1
(43) Pub. Date: Mar. 9, 2006

(54) Liquid crystal display device and driving method thereof

(75) Inventor: Hisashi Kawagoe, Hyogo (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: MITSUBISHI DENKI KABUSHIKI KAISHA, Tokyo (JP)

(21) Appl. No.: 11/212,713

(22) Filed: Aug. 29, 2005

(30) Foreign Application Priority Data
Sep. 3, 2004 (JP) 2004-256726

(51) Int. Cl. G09G 3/36

(52) U.S. Cl. 345/98

(57) ABSTRACT

A liquid crystal display device includes a pixel, an image signal switch connected to a signal line and a signal line drive circuit, a precharge switch connected to a scanning line and a precharge voltage supply circuit, and a scanning line drive circuit supplying successively a scanning line signal including a first signal and a second signal within one frame period to the scanning line in each row. The image signal switch is turned on while the first signal is supplied from the scanning line drive circuit, whereby an image signal is written into the pixels, and only the precharge switch is turned on while the second signal is supplied from the scanning line drive circuit, whereby a precharge voltage is written into the pixels.

### BACKGROUND OF THE INVENTION

1. Field of the Invention

The present invention relates to liquid crystal display devices and driving methods thereof, and especially to liquid crystal display devices displaying mainly moving images and driving methods thereof.

2. Description of the Background Art

Conventional image display devices are roughly divided into two types: an impulse-type display device (e.g. CRT) that displays an image for a sufficiently short period of time with respect to a fame period, and a hold-type display device (e.g. liquid crystal display device) that keeps holding an image display of a previous frame until a new image is written.

When the impulse-type display device is compared with the hold-type display device, the hold-type had a problem of causing a more conspicuous afterimage when displaying a moving image. This is due to pursuit movement of an eyeball and summation effects. That is, an eyeball moves successively through the pursuit movement in the direction of movement of an object, while responding with the addition of light stimulus from the object through which a line of sight passes. When the eyeball moves in response to the object, however, moving resolution is reduced significantly with the speed of movement of the object in the hold-type display device in which an image does not change within the same frame period.

In order to solve the above problem associated with the hold-type display device, a liquid crystal display device such as is shown in Japanese Patent Application Laid-Open No. 2002-041002 has been proposed. This document discloses a driving method that drives the hold-type display device but is close to the impulse-type display driving by providing a period during which an image is displayed and a period during which a black image is displayed by writing a black signal within one frame period.

In the above JP 2004-041002, since the period during which an image is displayed and the period during which a black image is displayed by writing a black signal are provided within one frame period, a signal supplied from a gate array to a pixel is divided into an image signal portion and a black signal portion within a horizontal scanning period, and the two portions are alternately repeated periodically. For this reason, it is required in JP 2004-041002 that a signal supplied to a pixel be different from a signal including only an image signal portion which is used in a common liquid crystal display device. This requires a gate array and so on that are different from those in the common liquid crystal display device, which incurs additional cost.

In addition, when forming the liquid crystal display device of JP 2004-041002 in which a signal divided into an image signal portion and a black signal portion within a horizontal scanning period is supplied to a pixel, a scanning line signal (first signal) for writing an image signal and a scanning line signal (second signal) for writing a black signal are phase shifted to one another, and therefore cannot be produced by a scanning line drive circuit formed by a simple shift register. For this reason, it is required in JP 2004-041002 that a scanning line drive circuit having a different structure from the conventional ones be employed, which incurs additional cost.

### SUMMARY OF THE INVENTION

It is an object of the present invention to provide a liquid crystal display device capable of writing an image signal and then a black signal within one frame period without dividing a signal into an image signal portion and a black signal portion within a horizontal scanning period, and a driving method thereof. It is also an object of the present invention to provide a liquid crystal display device including a scanning line drive circuit that produces a scanning line signal having different phases without employing a particular structure.

In an aspect of the invention, a liquid crystal display device includes: a liquid crystal panel; a scanning line; a signal line; a signal line drive circuit; an image signal switch; an image-signal-switch control circuit; a precharge voltage supply circuit; a precharge switch; a precharge-switch control circuit; and a scanning line drive circuit. Pixels are arranged in a matrix in the liquid crystal panel. The scanning line selectively scans a group of pixels positioned in the same row direction in the liquid crystal panel. The signal line supplies an image signal to a group of pixels positioned in the same column direction in the liquid crystal panel. The signal line drive circuit outputs the image signal to the signal line. The image signal switch is connected between the signal line and the signal line drive circuit. The image-signal-switch control circuit controls the image signal switch. The precharge voltage supply circuit supplies a precharge voltage corresponding to a black signal to the signal line. The precharge switch is connected between the signal line and the precharge voltage supply circuit. The precharge-switch control circuit controls the precharge switch. The scanning line drive circuit supplies a scanning line signal successively to the scanning line in each row, the scanning line signal including a first signal and a second signal within one frame period. The image signal switch is turned on while the first signal is supplied from the scanning line drive circuit, whereby the image signal is written into the pixels, and only the precharge switch is turned on while the second signal is supplied from the scanning line drive circuit, whereby the precharge voltage is written into the pixels.

A common image signal may be used without dividing a signal into an image signal portion and a black signal portion within a horizontal scanning period. It is therefore unnecessary to use a particular gate array and the like, thereby preventing additional cost.

In another aspect of the invention, a liquid crystal display device includes: a liquid crystal panel; a scanning line; a signal line; a signal line drive circuit; a scanning line drive circuit; and a gate array. Pixels are arranged in a matrix in the liquid crystal panel. The scanning line selectively scans a group of pixels positioned in the same row direction in the liquid crystal panel. The signal line supplies an image signal to a group of pixels positioned in the same column direction in the liquid crystal panel. The signal line drive circuit outputs the image signal to the signal line. The scanning line drive circuit supplies a scanning line signal successively to the scanning line in each row, the scanning line signal including a first signal and a second signal within one frame period. The gate array supplies the image signal divided into image display signal and black signal within a horizontal scanning period to the signal line drive circuit, and supplies an image period control signal controlling the timing of displaying the image display signal and a black period control signal controlling the timing of displaying the black signal within a horizontal scanning period to the scanning line drive circuit. The scanning line drive circuit includes: a first shift register producing the first signal for writing the image display signal into the pixels; a second shift register producing the second signal for writing the black signal into the pixels; a counter producing a timing signal to be supplied to the second shift register in order to delay the drive of the second shift register by a prescribed period of time with reference to the drive of the first shift register; a first logic circuit performing a logical operation on the image period control signal and the output of the first shift register; a second logic circuit performing a logical operation on the black period control signal and the output of the second shift register; a third logic circuit performing a logical operation on the output of the first logic circuit and the output of the second logic circuit; and a driver circuit supplying the output of the third logic circuit to the scanning line in each row.

The liquid crystal display device is capable of producing a scanning line signal including two pulses of the phase shifted fist and second signals without employing a particular circuit structure. It is therefore unnecessary to use a particular gate array and the like, thereby preventing additional cost.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows the structure of a liquid crystal display device according to a first preferred embodiment of the present invention;

FIGS. 2A to 2J show signal waveforms in the liquid crystal display device according to the first preferred embodiment;

FIG. 3 shows the structure of a scanning line drive circuit according to a second preferred embodiment of the present invention;

FIGS. 4A to 4E show signal waveforms in the scanning line drive circuit according to the second preferred embodiment;

FIG. 5 shows the structure of a scanning line drive circuit according to a modified example of the second preferred embodiment;

FIG. 6 shows the structure of a scanning line drive circuit according to a third preferred embodiment of the present invention;

FIGS. 7A to 7J show signal waveforms in the scanning line drive circuit according to the third preferred embodiment;

FIG. 8 shows the structure of a scanning line drive circuit according to a modified example of the third preferred embodiment;

FIG. 9 shows the structure of a scanning line drive circuit according to a fourth preferred embodiment of the present invention;

FIGS. 10A to 10G show signal waveforms in the scanning line drive circuit according to the fourth preferred embodiment;

FIG. 11 shows the structure of a scanning line drive circuit according to a modified example of the fourth preferred embodiment;

FIG. 12 shows the structure of a scanning line drive circuit according to a fifth preferred embodiment of the present invention;

FIG. 13 shows the structure of a scanning line drive circuit according to a modified example of the fifth preferred embodiment;

FIG. 14 shows the structure of a liquid crystal display device according to the present invention;

FIGS. 15A to 15G show signal waveforms in the liquid crystal display device according to the present invention; and

FIGS. 16A to 16F show display examples of the liquid crystal display device according to the present invention.

### DESCRIPTION OF THE PREFERRED EMBODIMENTS

### First Preferred Embodiment

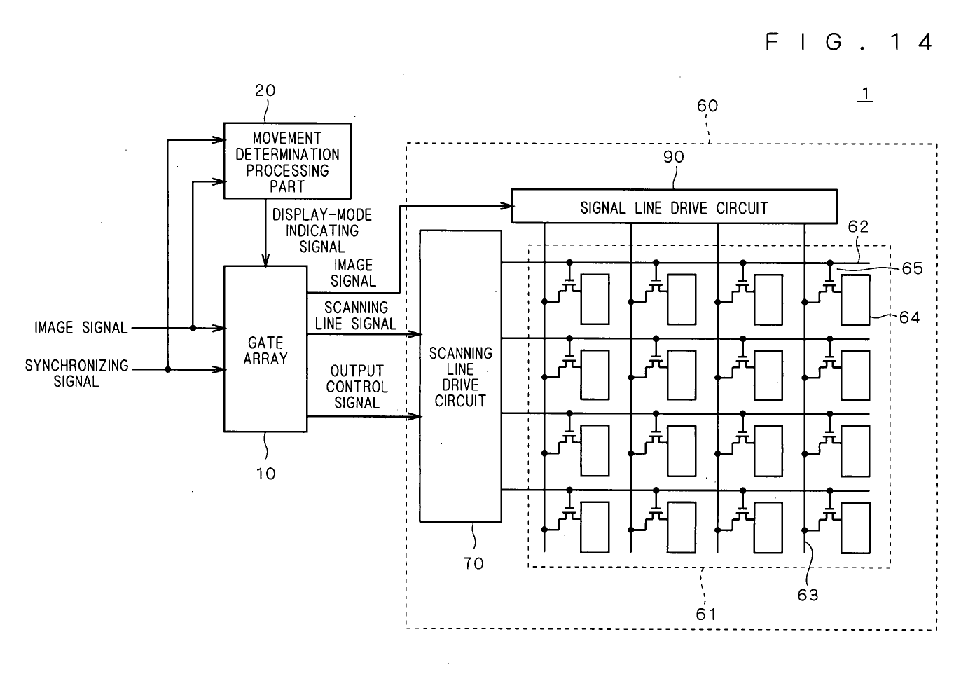

First, FIG. 14 shows the structure of a liquid crystal display device in which a signal supplied to a pixel is divided into an image signal portion and a black signal portion within a horizontal scanning period. A liquid crystal display device 1 shown in FIG. 14 includes a gate array 10, a movement determination processing part 20, and a liquid crystal module 60. The liquid crystal module 60 includes a liquid crystal panel 61, a scanning line drive circuit 70, and a signal line drive circuit 90. Further, the liquid crystal panel 61 includes a plurality of scanning lines 62, a plurality of signal lines 63 that cross the scanning lines 62, pixels 64 arranged in a matrix, and TFTs (Thin Film Transistor) 65 provided correspondingly to the pixels 64.

Each of the TFTs 65 has a gate electrode connected to the scanning line 62, a source electrode connected to the signal line 63, and a drain electrode connected to the pixel 64. Consequently, by controlling the voltage of the scanning line 62, each of the TFTs 65 connected to the scanning line 62 acts as a switching element transmitting an image signal from the signal line 63 to the pixel 64.

The movement determination processing part 20 captures frame images at prescribed intervals based on an image signal and a synchronizing signal, and examines the correlation between two successively captured frame images to determine whether the two frame images are moving image or static image. The result of this determination is included in a display-mode indicating signal to be transmitted to the gate array 10. The gate array 10 produces an image signal, a scanning line signal and an output control signal based on the externally transmitted image signal and synchronizing signal, and the display-mode indicating signal from the movement determination processing part 20.

Then, the image signal is supplied to the signal line drive circuit 90, and the scanning line signal and the output control signal are supplied to the scanning line drive circuit 70. The liquid crystal panel 61 is driven by the scanning line drive circuit 70 and the signal line drive circuit 90. The scanning line drive circuit 70 includes a shift register though not shown, by which the scanning line signal is shifted successively to be transmitted into the shift register. The output of the scanning line drive circuit 70 is controlled by the output control signal.

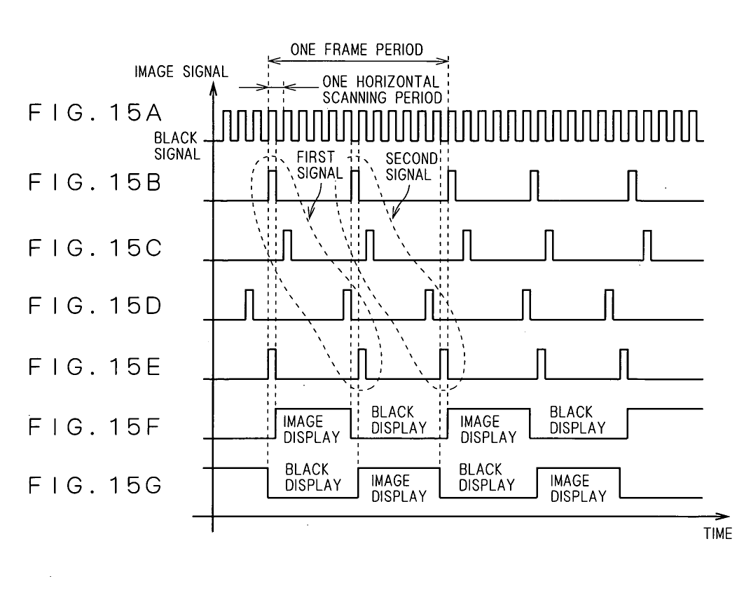

Next, a driving method of performing black writing of 50% duty in the liquid crystal display device 1 shown in FIG. 14 will be described. FIGS. 15A to 15G show signal waveforms of this driving method. FIG. 15A shows a signal supplied to the signal line 63, which is divided into an image signal potion and a black signal portion within a horizontal scanning period. In the signal waveforms shown in FIGS. 15A to 15G, black is displayed when a voltage written into the pixel 64 is in a non-voltage state. Thus the liquid crystal display device 1 is normally black.

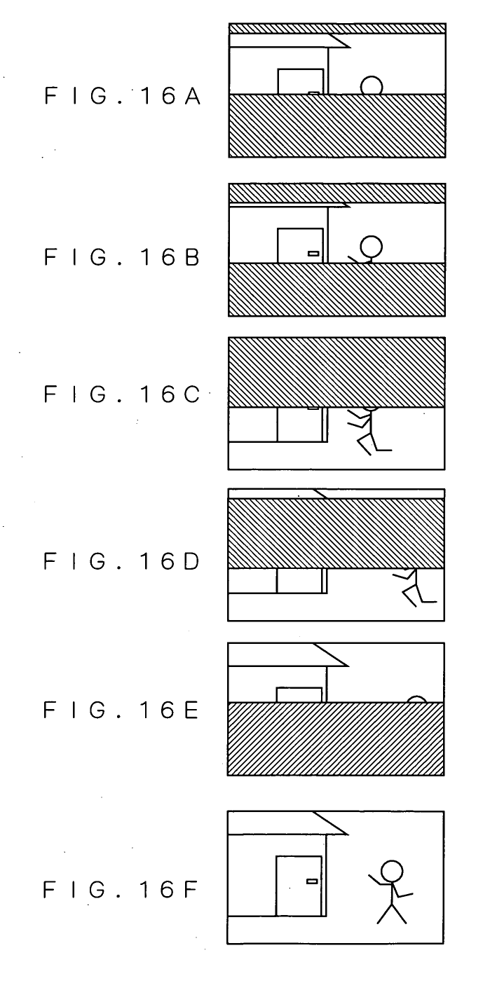

FIGS. 15B and 15C show waveforms of the scanning line signal output from the scanning line drive circuit 70 to the scanning lines 62 in the first and second lines of the liquid crystal panel 61, respectively. The image signal is written by the first signal of the scanning line signal into the pixels 64 connected to the scanning lines 62 in the first and second lines, whereby an image is displayed on the pixels 64 in the first and second lines. Here, it is assumed that the total number of scanning lines of the liquid crystal panel 61 is Gall. In a signal waveform shown in FIG. 15D, the first signal of the scanning line signal is supplied to the scanning line 62 in a Gall/2 line, namely half the screen. At the same time, in the signal waveform shown in FIG. 15B, the second signal of the scanning line signal is supplied to the scanning line 62 in the first line, whereby the black signal shown in FIG. 15A is written into the group of pixels connected to the scanning line 62 in the first line. At this time, the liquid crystal display device 1 displays an image shown in FIG. 16A. In FIG. 16A, an image is written through the Gall/2 line of the screen, while black is written into the pixels 64 in the first line.

Likewise, FIG. 15E shows a waveform of the scanning line signal supplied to the scanning line 62 in a (Gall/2)+1 line. The image signal is written by the first signal of the scanning line signal into the pixels 64 connected to the scanning line 62 in the (Gall/2)+1 line. At the same time, in the signal waveform shown in FIG. 15C, the second signal of the scanning line signal is supplied to the scanning line 62 in the second line, whereby the black signal is written into the pixels 64 in the second line. At this time, the liquid crystal display device 1 displays an image shown in FIG. 16B. In FIG. 16B, an image is written through the (Gall/2)+1 line of the screen, while black is written into the pixels 64 through the second line. After that, the scanning line signal is supplied in a similar fashion to the scanning lines 62 through a Gall line.

FIG. 16C shows an image displayed when the first signal of the scanning line signal is supplied to the scanning line 62 in the Gall line, while the second signal of the scanning line signal is supplied to the scanning line 62 in a (Gall/2)−1 line. FIG. 16D shows an image displayed when the first signal of the scanning line signal is supplied to the scanning line 62 in the first line, while the second signal of the scanning line signal is supplied to the scanning line 62 in the Gall/2 line. Further, FIG. 16E shows an image displayed when the first signal of the scanning line signal is supplied to the scanning line 62 in the Gall/2 line, while the second signal of the scanning line signal is supplied to the scanning line 62 in the Gall line. By repeating the drive that attains a screen display shown in FIGS. 16A to 16E, the liquid crystal display device 1 is capable of a display close to the impulse display.

FIGS. 15F and 15G show voltage waveforms of the pixels connected to the scanning lines 62 during such driving. FIG. 15F shows a voltage waveform of the pixels connected to the scanning line 62 in the first line, in which an image is displayed while the first signal is scanned from the first line through the Gall/2 line, and black is displayed while the first signal is scanned from the (Gall/2)+1 line through the Gall line. Likewise, FIG. 15G shows a voltage waveform of the pixels connected to the scanning line 62 in the (Gall/2)+1 line, in which black is displayed while the first signal is scanned from the first line through the Gall/2 line, and an image is displayed while the first signal is scanned from the (Gall/2)+1 line through the Gall line. FIG. 16F shows an exemplary static image of 100% duty, in which case black is not displayed.

Whereas the case of 50% duty has been described with reference to FIGS. 15A to 15G and FIG. 16, the duty ratio may be adjusted freely from (100/Gall)% to 100% at intervals of (100/Gall)%. With a series of the above operations, the liquid crystal display device 1 is capable of simultaneously writing and erasing in one screen by writing the image signal by the first signal of the scanning line signal and then the black signal by the second signal of the scanning line signal. Thus, the liquid crystal display device 1, though a hold-type display device, attains a display close to the impulse display.

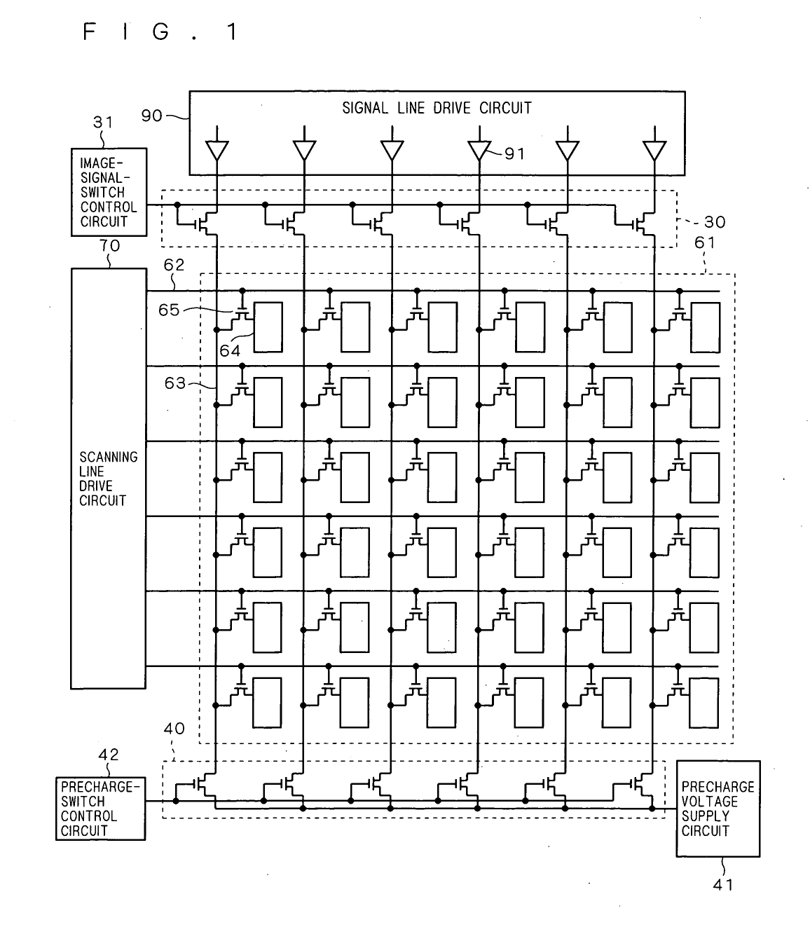

Next, FIG. 1 shows the structure of a liquid crystal display device according to a first preferred embodiment of the present invention, in which a signal supplied to pixels is not divided into an image signal portion and a black signal portion within a horizontal scanning period. This liquid crystal display device includes a precharge circuit. The same parts as those in FIG. 14 are referred to by the same reference numerals. It is to be noted that the image signal supplied to the signal line drive circuit 90 is not divided into an image signal portion and a black signal portion within a horizontal scanning period as shown in FIG. 15A, but only includes an image signal portion.

An image signal switch 30 shown in FIG. 1 is provided between, and controls the connection between the signal line 63 of the liquid crystal panel 61 and the signal line drive circuit 90. An image-signal-switch control circuit 31 connects between the signal line drive circuit 90 and the signal line 63 during a period other than a precharge period, and controls the image signal switch 30 so that the image signal output from a source level driver 91 of the signal line drive circuit 90 is supplied to the signal line 63.

The liquid crystal display device according to this embodiment further includes a precharge voltage supply circuit 41. A precharge switch 40 is provided between, and controls the connection between the precharge voltage supply circuit 41 and the signal line 63 of the liquid crystal panel 61. The precharge switch 40 is also connected to a precharge-switch control circuit 42. The precharge-switch control circuit 42 connects between the precharge voltage supply circuit 41 and the signal line 63 only during the precharge period, and controls the precharge switch 40 so that a precharge voltage output from the precharge voltage supply circuit 41 is supplied to the signal line 63.

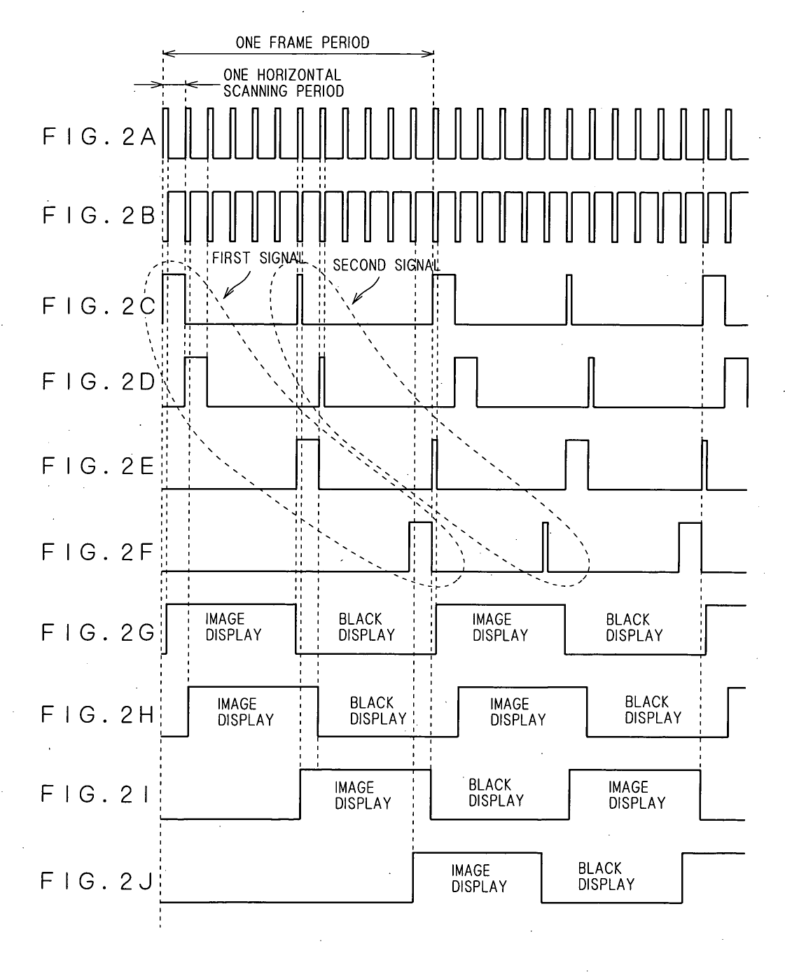

FIGS. 2A to 2J show signal waveforms in the liquid crystal display device according to this embodiment. Black writing of 50% duty is performed in the driving indicated by these signal waveforms. Unlike the signal waveform shown in FIG. 15A, the image signal according to this embodiment is not divided within a horizontal scanning period, though not shown. The driving method according to this embodiment is therefore independent of the type of liquid crystal panel (normally black, normally white) or a driving mode (inversion drive), and may be described only by the waveform of the scanning line signal output from the scanning line drive circuit 70, without consideration given to the image signal.

FIGS. 2A shows the waveform of a precharge-switch control signal that activates the precharge switch 40 during the precharge period within a horizontal scanning period. FIG. 2B shows the waveform of an image-signal-switch control signal that activates the image signal switch 30 during the period (image signal period) other than the precharge period within a horizontal scanning period. FIGS. 2C and 2D show waveforms of the scanning line signal in the first and second lines from the scanning line drive circuit 70, respectively. The scanning line signal shown in FIGS. 2C and 2D includes a first signal having a pulse width of one horizontal scanning period, which turns the TFT 65 on.

Both the precharge period and the image signal period are always included in one horizontal scanning period during which the TFT 65 is turned on. During the precharge period, the precharge-switch control signal shown in FIG. 2A is transmitted from the precharge-switch control circuit 42 to turn the precharge switch 40 on. This causes the precharge voltage output from the precharge voltage supply circuit 41 to be supplied to a group of pixels 64, whereby black is displayed on the group of pixels. 64. Then, during the image signal period after the completion of precharge, the image-signal-switch control signal shown in FIG. 2B is transmitted from the image-signal-switch control circuit 31 to turn the image signal switch 30 on. This causes the image signal output from the signal line drive circuit 90 to be supplied to a group of pixels 64, whereby an image is displayed on the group of pixels. 64.

As can be seen from FIGS. 2C and 2D, the first signal of the scanning line signal is supplied to the TFTs 65 with successively shifted timings so as not be overlapped between the first and second lines. The first signal of the scanning line signal is likewise supplied to the TFTs 65 with successively shifted timings in the subsequent lines as well, to be supplied to all the scanning lines (rows) within one frame period. This means all the scanning lines 62 are selected by the scanning line drive circuit 70.

Assuming that the total number of scanning lines (the total number of rows) is Gall, in a signal waveform shown in FIG. 2E, the first signal of the scanning line signal is supplied to the TFTs 65 in the (Gall/2)+1 line. At the same time, in the signal waveform shown in FIG. 2C, the second signal of the scanning line signal is supplied to the TFTs 65 in the first line. This second signal of the scanning line signal has a pulse width of one precharge period, and is in synchronization with the precharge-switch control signal. Thus, the precharge voltage is supplied to the scanning lines 62 in the first line and in the (Gall/2)+1 line, whereby black is displayed on the groups of pixels 64 connected to those scanning lines.

During the subsequent image signal period, the image signal is written into the group of pixels 64 in the (Gall/2)+1 line because the first signal of the scanning line signal has been supplied to the scanning line 62 in the (Gall/2)+1 line. At the same time, however, the second signal of the scanning line signal is supplied to the scanning line 62 in the first line, whereby the TFTs 65 in the first line are turned off and no image signal is written into the group of pixels 64 in the first line during the image signal period. A similar process is performed on the respective scanning lines 62, and a display of one screen is completed with the scanning line signal being supplied to the Gall line, as shown in FIG. 2F.

With a series of the above operations, the first signal of the scanning line signal for writing the precharge voltage and the image signal and the subsequent second signal of the scanning line signal for writing only the precharge voltage are supplied to the respective scanning lines 62 within one frame period in this embodiment. The liquid crystal display device according to this embodiment is therefore capable of simultaneously writing and erasing an image of one screen without using a signal divided into an image signal portion and a black signal portion. Consequently, a display close to the impulse display-is attained thus reducing the occurrence of an afterimage.

That is, the state of display of the group of pixels 64 in the first line is, as shown in FIG. 2G, that an image is displayed upon supplying both the first signal of the scanning line signal and the ON signal of the image-signal-switch control signal until supplying the second signal of the scanning line, and black is displayed afterward. An image is likewise displayed with successively shifted timings in the second and subsequent lines as well. FIGS. 2H, 2I and 2J show the states of display of the groups of pixels 64 in the second line, in the Gall/2 line, and in the Gall line, respectively.

As has been described, the liquid crystal display device and the driving method thereof according to this embodiment, which provides a black display period after image display by using the precharge circuit, is capable of a display close to the impulse display without dividing a signal into an image signal portion and a black signal portion within a horizontal scanning period, thereby preventing the occurrence of an afterimage of a moving image.

Whereas the case of performing black writing of 50% duty has been described with reference to the signal waveforms shown in FIGS. 2A to 2J, it is needless to say that the duty ratio may be determined freely by changing the timing of the second signal only for precharge. In addition, whereas the image signal switch 30 and the precharge switch 40 are arranged at opposite ends of the signal line 63 in the liquid crystal display device shown in FIG. 1, it is needless to say that both the switches may be arranged at one end of the signal line 63, or may be put together into one circuit.

Further, whereas the image signal switch 30 is arranged in one-to-one correspondence to the signal line 63 in the liquid crystal display device according to this embodiment, it is needless to say that a multiplexer may be employed with a ratio of 2:1 or 3:1. Moreover, whereas a circuit part including the image signal switch 30, precharge switch 40, and the like and the liquid crystal panel 61 are formed independently of and connected to each other in the liquid crystal display device shown in FIG. 1, it is needless to say that the circuit part may be formed on the liquid crystal panel 61.

### Second Preferred Embodiment

In a second preferred embodiment of the present invention, the structure of the scanning line drive circuit 70 in the liquid crystal display device according to the first preferred embodiment will be specifically described. The scanning line drive circuit 70 according to this embodiment outputs two scanning line signals (first signal and second signal) having a pulse width of the horizontal scanning period and a pulse width of the precharge period, respectively, by using two shift registers.

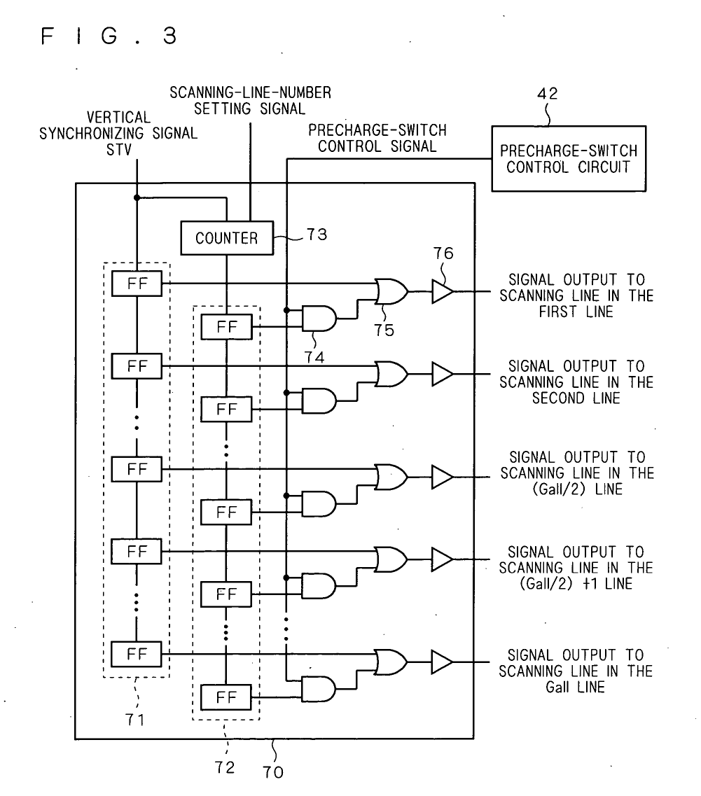

FIG. 3 shows the structure of the scanning line drive circuit 70 according to this embodiment. This scanning line drive circuit 70 includes a first shift register 71 latched at the timing of a vertical synchronizing signal STV. The first shift register 71 includes as many flip-flop circuits as the scanning lines 62, and produces the first signal of the scanning line signal to be supplied to the respective scanning lines 62. The scanning line drive circuit 70 shown in FIG. 3 further includes a counter 73 outputting a timing signal, and a second shift register 72 latched at the output timing of the counter 73. The timing signal is a signal shifted by horizontal scanning periods in accordance with a prescribed number of scanning lines with reference to the vertical synchronizing signal STV based on a scanning-line-number setting signal. The second shift register 72 includes as many flip-flop circuits as the scanning lines 62, and produces the second signal of the scanning line signal to be supplied to the respective scanning lines 62.

The scanning line drive circuit 70 shown in FIG. 3 further includes an AND circuit 74 performing a logical operation on the output of the second shift register 72 and the precharge-switch control signal from the precharge-switch control circuit 42 to produce the second signal having a pulse width of one precharge period, an OR circuit 75 performing an OR operation on the output of the first shift register 71 and the output of the AND circuit 74, and a gate level driver 76 adjusting the level of a signal output from the OR circuit 75. There are as many AND circuits 74, OR circuits 75 and gate level drivers 76 as the scanning lines 62.

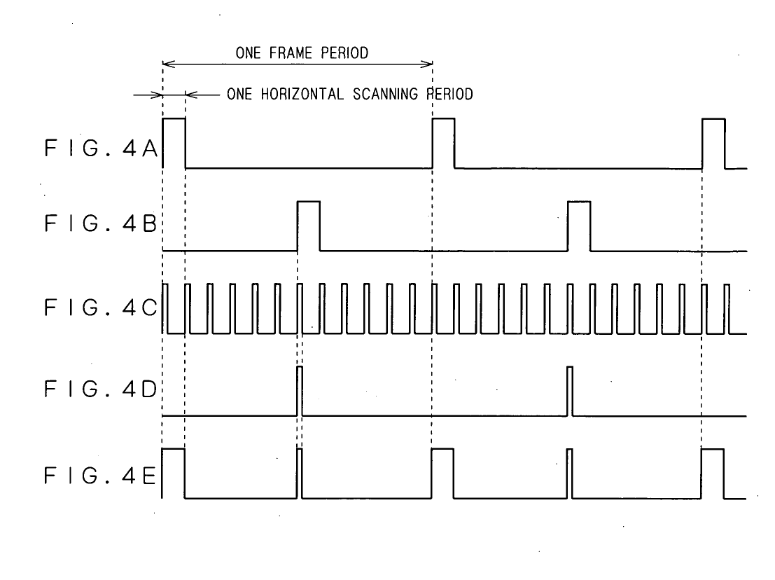

FIGS. 4A to 4E show signal waveforms in the scanning line drive circuit 70 according to this embodiment. The operation of the scanning line drive circuit 70 according to this embodiment will be specifically described with reference to FIGS. 4A to 4E. FIG. 4A shows an output signal (first signal of the scanning line signal) in a first stage of the first shift register 71, which is latched at the timing of the vertical synchronizing signal STV. The vertical synchronizing signal STV is also input to the counter 73. The counter 73 supplies the second shift register 72 with the timing signal shifted by horizontal scanning periods in accordance with a prescribed number of scanning lines with reference to the vertical synchronizing signal STV based on the scanning-line-number setting signal.

The second shift register 72 is latched by the timing signal from the counter 73. FIG. 4B shows an output signal in a first stage of the second shift register 72, which is latched by the timing signal from the counter 73. Since the second signal of the scanning line signal has a pulse width of one precharge period, it is required that the output signal of the second shift register 72 having a pulse width of one horizontal scanning period have a pulse width of one precharge period. For this reason, the output signal of the second shift register 72 and the precharge-switch control signal are subjected to an AND operation by the AND circuit 74. FIG. 4C shows the precharge-switch control signal. FIG. 4D shows a resultant signal after the AND operation on the output signal of the second shift register 72 and the precharge-switch control signal.

Thereafter, the output signal of the first shift register 71 and the output signal of the AND circuit 74 are subjected to an OR operation by the OR circuit 75 to be output from the gate level driver 76, thus attaining an output waveform shown in FIG. 4E. In short, the output waveform of the scanning line drive circuit 70 shown in FIG. 4E includes the first signal of the scanning line signal capable of writing the precharge voltage and the image signal into the TFT 65 and the second signal of the scanning line signal capable of writing only the precharge voltage thereafter within one frame period. Whereas only the scanning line signal in the first line has been described with reference to FIG. 4A to 4E, it is needless to say that a similar process is performed successively on every scanning line signal, as indicated in FIG. 3 of the first preferred embodiment, thereby producing output signals.

As has been described, the scanning line drive circuit 70 according to this embodiment is capable of writing an image signal and then a black signal within one frame period without dividing a signal into an image signal portion and a black signal portion within a horizontal scanning period, and further capable of precharging at any given duty ratio by the scanning-line-number setting signal supplied to the counter 73.

<Modification>

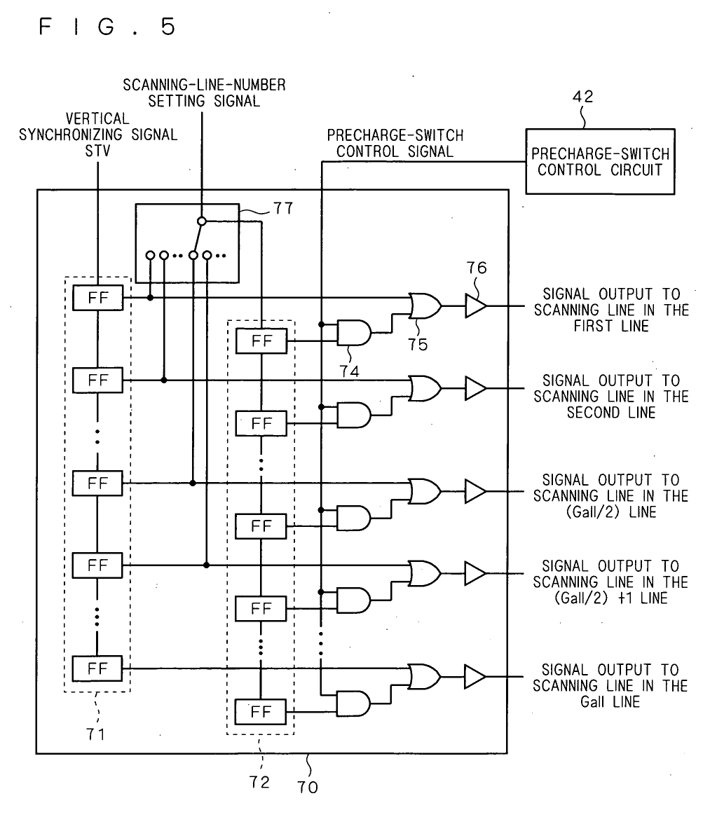

FIG. 5 shows a modified example of the scanning line drive circuit 70 according to the second preferred embodiment. The difference from the FIG. 3 circuit is replacing the counter 73 by a switch 77 so that the timing signal in accordance with the scanning-line-number setting signal output from the counter 73 is replaced by the output signal of the first shift register 71. The switch 77 switches a switch so that the output signal of the flip-flop circuit in the (Gall/2)+1 stage in the first shift register 71 is supplied as the timing signal to the second shift register 72, for example. Although wiring is increased with increase in setting number of duty ratios, this structure may be more simplified than the scanning line drive circuit 70 shown in FIG. 3 by reducing the setting number.

### Third Preferred Embodiment

In a third preferred embodiment of the present invention, the second shift register 72 is omitted in the scanning line drive circuit 70 according to the second preferred embodiment by fixing the settings of the counter 73 to half the number of scanning lines.

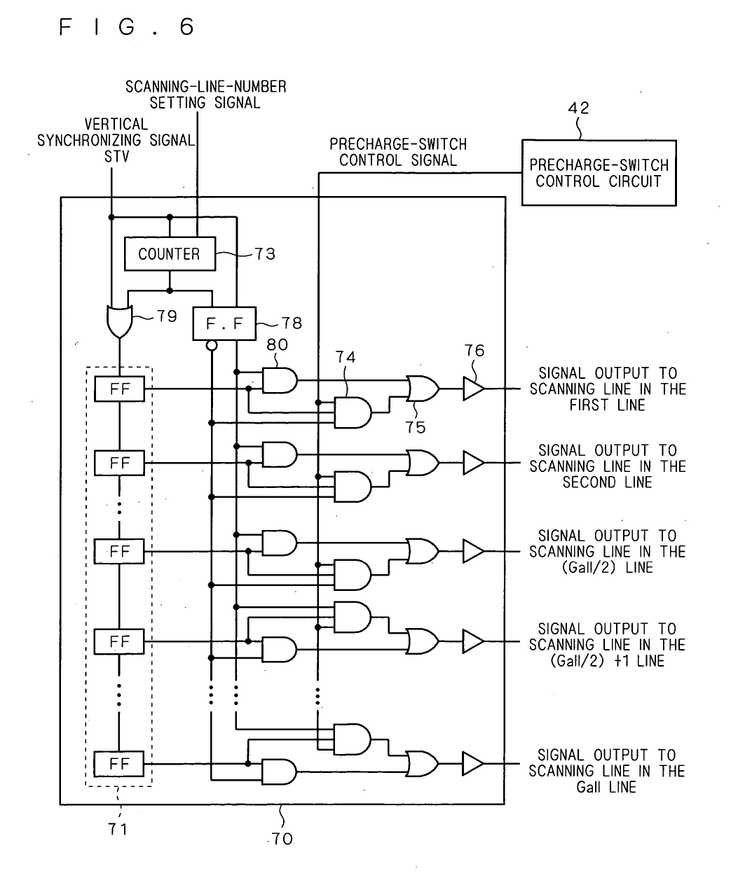

FIG. 6 shows the structure of the scanning line drive circuit 70 according to this embodiment. In this scanning line drive circuit 70, the counter 73 outputs a timing signal shifted by horizontal scanning periods in accordance with half the total number of scanning lines with reference to the vertical synchronizing signal STV. A flip-flop circuit 78 is supplied with the vertical synchronizing signal STV and the timing signal from the counter 73, and outputs a signal (hereafter called an FF signal) that is switched between a high state and a low state within half a frame period and its inversion signal (hereafter called an FF inversion signal).

The first shift register 71 is supplied with the vertical synchronizing signal STV and the timing signal from the counter 73 via an OR circuit 79. Then, the outputs of the first shift register 71 from the first line through the Gall/2 line (hereafter called the first half lines) are input either to an AND circuit 80 together with the FF signal, or to the AND circuit 74 together with the FF inversion signal and the precharge-switch control signal. The outputs of the first shift register 71 from the (Gall/2)+1 line through the Gall line (hereafter called the latter half lines) are input either to the AND circuit 80 together with the FF inversion signal, or to the AND circuit 74 together with the FF signal and the precharge-switch control signal. Then, the outputs of the AND circuits 74 and 80 are input to the OR circuit 75 and then to the scanning line 62 via the gate level driver 76.

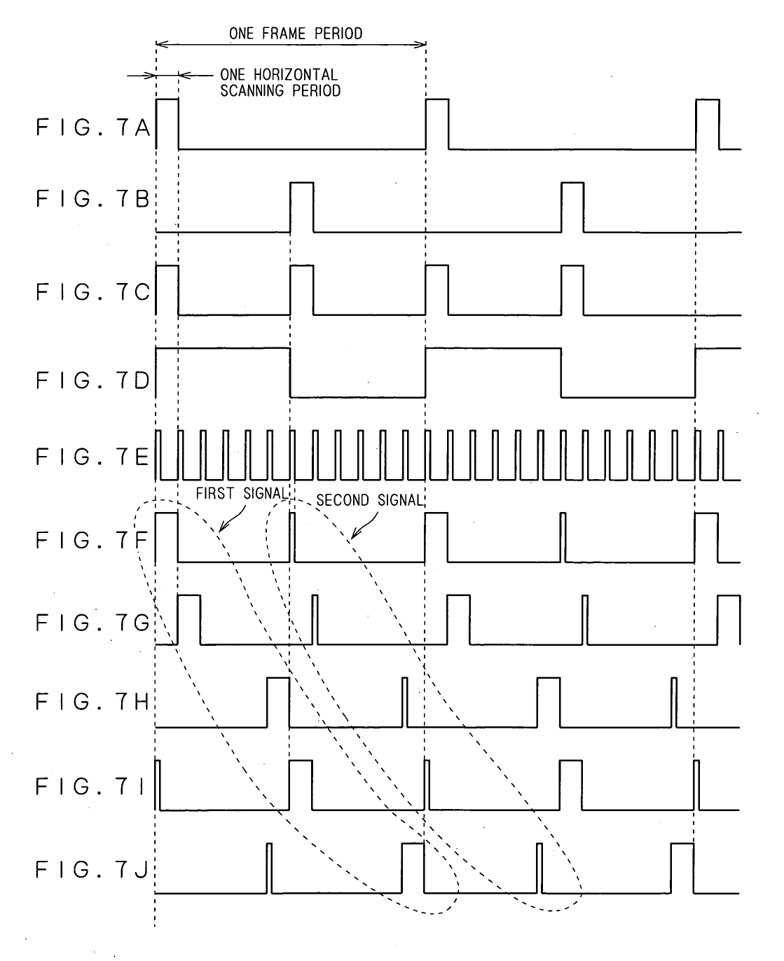

FIGS. 7A to 7J show signal waveforms in the scanning line drive circuit 70 according to this embodiment. The operation of the scanning line drive circuit 70 according to this embodiment will be specifically described with reference to FIGS. 7A to 7J. FIG. 7A shows the vertical synchronizing signal STV. FIG. 7B shows the timing signal (signal with a pulse being produced in the position of (Gall/2)+1 line) output from the counter 73, which is shifted by horizontal scanning periods in accordance with half the total number of scanning lines Gall with reference to the vertical synchronizing signal STV. The vertical synchronizing signal STV and the timing signal from the counter 73 are input to the OR circuit 79, which outputs a signal as shown in FIG. 7C to the first shift register 71. As shown in FIG. 7C, the input signal of the first shift register 71 is latched twice within one frame period.

The vertical synchronizing signal STV and the timing signal from the counter 73 are also input to the flip-flop circuit 78, which outputs the FF signal that is switched between a high state and a low state within half a frame period as shown in FIG. 7D. The flip-flop circuit 78 also outputs the FF inversion signal which is an inversion signal of the FF signal, though now shown in FIGS. 7A to 7J.

Since the first shift register 71 is latched twice within one frame period, as shown in FIG. 7C, the signals output from the respective flip-flop circuits therein include a first pulse and a second pulse delayed by horizontal scanning periods in accordance with half the total number of scanning lines Gall within one frame period. Both the two pulses have the same pulse width of one horizontal scanning period.

However, the scanning line signal supplied to the scanning line 62 includes the first signal having a pulse width of one horizontal scanning period and the second signal having a pulse width of one precharge period, as shown in FIG. 7F to 7G. It is therefore required that the signal output from the first shift register 71 be output as the above scanning line signal via the AND circuits 74 and 80, the OR circuit 75, and the gate level driver 76. The operation thereof will be described.

The outputs of the first shift register 71 from the first line through the Gall/2 line (first half lines) are input to the AND circuit 80 together with the FF signal. Thus, the output of the first shift register 71 in the first half during one frame period is output as the first signal having a pulse width of one horizontal scanning period from the AND circuit 80. The outputs of the first shift register 71 in the first half lines are also input to the AND circuit 74 together with the FF inversion signal and the precharge-switch control signal. Thus, the output of the first shift register 71 in the latter half during one frame period is output as the second signal having a pulse width of the precharge-switch control signal from the AND circuit 74.

The AND circuits 74 and 80 in the first half lines output scanning line signals as shown in FIGS. 7F to 7H via the OR circuit 75 and the gate level driver 76. The scanning line signals shown in FIGS. 7F to 7H include the first signal and the second signal delayed by horizontal scanning periods in accordance with half the total number of scanning lines. FIG. 7E shows a signal waveform of the precharge-switch control signal.

On the other hand, the outputs of the first shift register 71 from the (Gall/2)+1 line through the Gall line (latter half lines) are input to the AND circuit 80 together with the FF inversion signal. Thus, the output of the first shift register 71 in the latter half during one frame period is output as the first signal having a pulse width of one horizontal scanning period from the AND circuit 80. The outputs of the first shift register 71 in the latter half lines are also input to the AND circuit 74 together with the FF signal and the precharge-switch control signal. Thus, the output of the first shift register 71 in the first half during one frame period is output as the second signal having a pulse width of the precharge-switch control signal from the AND circuit 74.

The AND circuits 74 and 80 in the latter half lines output scanning line signals as shown in FIGS. 71 and 7J via the OR circuit 75 and the gate level driver 76. The scanning line signals shown in FIGS. 71 and 7J include the second signal and the first signal delayed by horizontal scanning periods in accordance with half the total number of scanning lines.

As has been described, the scanning line drive circuit 70 according to this embodiment is capable of writing an image signal and then a black signal within one frame period without dividing a signal into an image signal portion and a black signal portion within a horizontal scanning period. Further, the second shift register 72 may be omitted in the scanning line drive circuit 70 according to this embodiment by shifting the second signal by horizontal scanning periods in accordance with half the total number of scanning lines with respect to the first signal, namely, fixing a 50% duty. It is needless to say that, when the number of outputs of the scanning line drive circuit 70 and the number of scanning lines are different from each other, connection should be established such that not the respective first lines but the respective Gall/2 lines are aligned to attain similar black writing as when the number of outputs of the scanning line drive circuit 70 and the number of scanning lines are the same.

On the contrary, when the scanning line drive circuit 70 is formed on a liquid crystal panel and the number of outputs of the scanning line drive circuit 70 and the number of scanning lines are of the same number, it is needless to say that the counter 73 may be formed as a fixed counter having a fixed number of counters and not requiring the scanning-line-number setting signal.

<Modification>

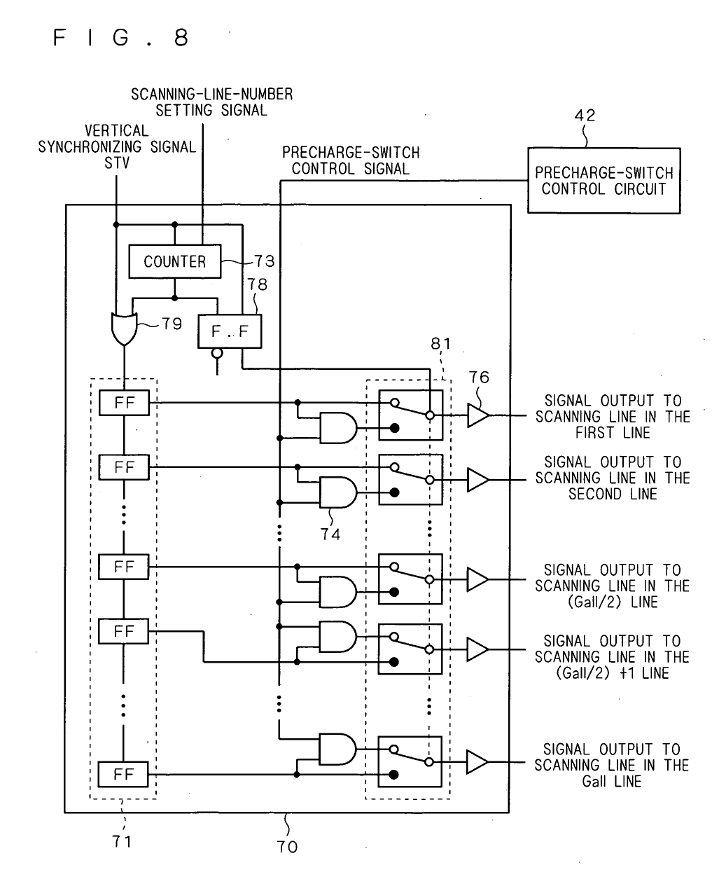

FIG. 8 shows the structure of the scanning line drive circuit 70 according to a modified example of the third preferred embodiment. In the scanning line drive circuit 70 shown in FIG. 6, the AND circuits 74 and 80 perform AND operations on the output of the first shift register 71 and the FF signal or FF inversion signal from the flip-flop circuit 78, and the OR circuit 75 performs an OR operation on the outputs of the AND circuits 74 and 80.

In the scanning line drive circuit 70 shown in FIG. 8, however, the OR circuit 75 is replaced by a switch 81 switching between the output of the first shift register 71 and the output of the AND circuit 74 based on the FF signal from the flip-flop circuit 78. This eliminates the AND circuit 80 and reduces wiring, thus attaining a simplified structure.

The operation of the scanning line drive circuit 70 shown in FIG. 8 will be specifically described. In each of the switches 81 from the first line through the Gall/2 line, the output of the first shift register 71 is connected to a white side terminal and the output of the AND circuit 74 supplied with the output of the first shift register 71 and the precharge-switch control signal is connected to a black side terminal. When the FF signal input to the switch 81 is in a high state, the white side terminal is turned on, whereby the output of the first shift register 71 is input to the gate level driver 76. When the FF signal input to the switch 81 is in a low state, the black side terminal is turned on, whereby the output of the AND circuit 74 is input to the gate level driver 76. Consequently, the scanning line signal includes a first signal having a pulse width of one horizontal scanning period and a second signal having a pulse width of one precharge period within one frame period. In addition, the second signal of the scanning line signal is delayed by horizontal scanning periods in accordance with half the total number of scanning lines with reference to the first signal.

Meanwhile, in each of the switches 81 from the (Gall/2)+1 line through the Gall line, the output of the first shift register 71 is connected to the black side terminal and the output of the AND circuit 74 is connected to the white side terminal. When the FF signal input to the switch 81 is in a high state, the white side terminal is turned on, whereby the output of the AND circuit 74 is input to the gate level driver 76. When the FF signal input to the switch 81 is in a low state, the black side terminal is turned on, whereby the output of the first shift register 71 is input to the gate level driver 76. Consequently, the scanning line signal includes a first signal having a pulse width of one horizontal scanning period and a second signal having a pulse width of one precharge period within one frame period. In addition, the first signal of the scanning line signal is delayed by horizontal scanning periods in accordance with half the total number of scanning lines with reference to the second signal.

As has been described, the scanning line drive circuit 70 according to this modified example is again capable of writing an image signal and then a black signal within one frame period without dividing a signal into an image signal portion and a black signal portion within a horizontal scanning period. Further, the AND circuit 80 is eliminated and wiring is reduced, thus attaining a simplified structure.

### Fourth Preferred Embodiment

In a fourth preferred embodiment of the present invention, the structure of a scanning line drive circuit will be specifically described which supplies a scanning line with a scanning line signal including phase shifted first and second signals. The scanning line drive circuit according to this embodiment is applied not to the liquid crystal display device including the image signal switch 30, precharge switch 40 and the like as shown in FIG. 1, but to the liquid crystal display device such as shown in FIG. 14.

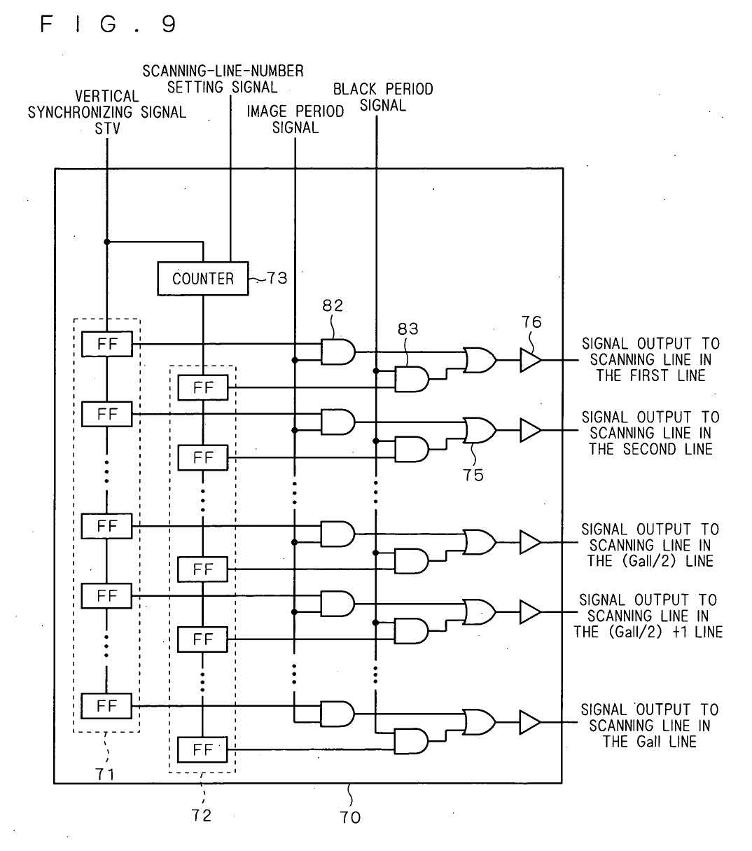

FIG. 9 shows the structure of the scanning line drive circuit 70 according to this embodiment. This scanning line drive circuit 70 includes the first shift register 71 for image signal latched by the vertical synchronizing signal STV, and the second shift register 72 for black writing latched by the timing signal from the counter 73. This scanning line drive circuit 70 further includes an AND circuit 82 performing an AND operation on the output of the first shift register 71 and an image period signal, an AND circuit 83 performing an AND operation on the output of the second shift register 72 and a black period signal, an OR circuits 75 supplied with the outputs of the AND circuits 82 and 83, and the gate level driver 76 supplying the output of the OR circuit 75 to the scanning line 62.

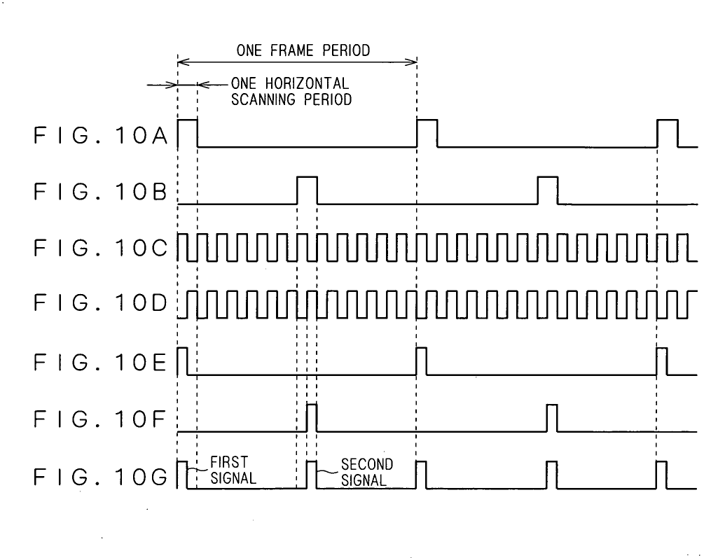

FIGS. 10A to 10G show signal waveforms in the scanning line drive circuit 70 according to this embodiment. The operation of the scanning line drive circuit 70 according to this embodiment will be specifically described with reference to FIGS. 10A to 10G. FIG. 10A shows an output signal waveform in a first stage of the first shift register 71, which is latched by the vertical synchronizing signal STV. As shown in FIG. 9, the vertical synchronizing signal STV is also input to the counter 73. The counter 73 supplies the second shift register 72 with the timing signal delayed by horizontal scanning periods in accordance with a prescribed number of scanning lines with reference to the vertical synchronizing signal STV based on the scanning-line-number setting signal. FIG. 10B shows an output signal waveform in a first stage of the second shift register 72, which is latched by this timing signal.

Though not shown in FIGS. 10A to 10G, a signal supplied to the signal line 63 has a waveform divided into an image signal portion and a black signal potion within one horizontal scanning period such as shown in FIG. 15A. In this embodiment, the output signal of the first shift register 71 writes only an image signal and the output signal of the second shift register 72 writes only a black signal. Thus, it is required to produce a scanning line signal (first signal) for writing only an image signal and a scanning line signal (second signal) for writing only a black signal.

Initially, in order to produce the scanning line signal (first signal) for writing only an image signal, the output signal of the first shift register 71 and the image period signal are subjected to an AND operation by the AND circuit 82. The image period signal is in a high state during an image display period within every horizontal scanning period, as shown in FIG. 10C. FIG. 10E shows a resultant signal waveform after the AND operation by the AND circuit 82 on the FIG. 10A waveform and FIG. 10C waveform.

Likewise, in order to produce the scanning line signal (second signal) for writing only a black signal, the output signal of the second shift register 72 and the black period signal are subjected to an AND operation by the AND circuit 83. The black period signal is in a high state during a black display period within every horizontal scanning period, as shown in FIG. 10D. FIG. 10F shows a resultant signal waveform after the AND operation by the AND circuit 83 on the FIG. 10B waveform and FIG. 10D waveform. Thereafter, the outputs of the AND circuits 82 and 83 are subjected to a logical operation by the OR circuit 75, whereby a scanning line signal such as shown in FIG. 10G is supplied from the gate level driver 76 to the scanning line 62.

The scanning line signal shown in FIG. 10G includes a first signal corresponding to the image signal period and a second signal corresponding to the black signal period. By supplying this scanning line signal and the signal such as shown in FIG. 15A to the TFT 65, a period during which an image is displayed and a period during which the image is erased (black is written) may be provided within one frame period. In addition, the second signal is delayed by horizontal scanning periods in accordance with a prescribed number of scanning lines set by the counter 73 with reference to the first signal. Whereas only the scanning line signal only in the first line has been described with reference to FIGS. 10A to 10G, it is needless to say that a similar process is performed successively on every scanning line signal, thereby producing output signals.

As has been described, the scanning line drive circuit 70 according to this embodiment is capable of producing a scanning line signal including two pulses of the phase shifted first and second signals without employing a particular structure.

<Modification>

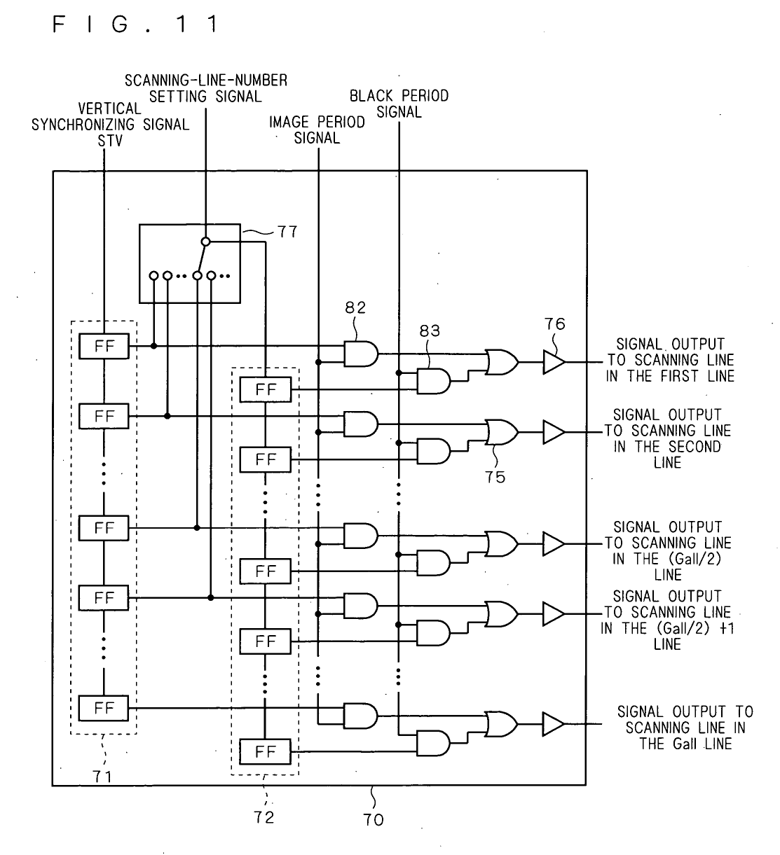

FIG. 11 shows the structure of the scanning line drive circuit 70 according to a modified example of the fourth preferred embodiment. The difference from the FIG. 9 circuit is replacing the counter 73 by the switch 77. The switch 77 supplies the output of the first shift register 71 that is output after lapse of horizontal scanning periods in accordance with a prescribed number of scanning periods as a timing signal based on the scanning-line-number setting signal.

The same effects as the fourth preferred embodiment are obtained again in this modified example. Although wiring is increased with increase in setting number of duty ratios, this structure may be simplified by reducing the setting number.

### Fifth Preferred Embodiment

In a fifth preferred embodiment of the present invention, the second shift register 72 is omitted in the scanning line drive circuit 70 according to the fourth preferred embodiment by fixing the settings of the counter 73 to half the number of scanning lines.

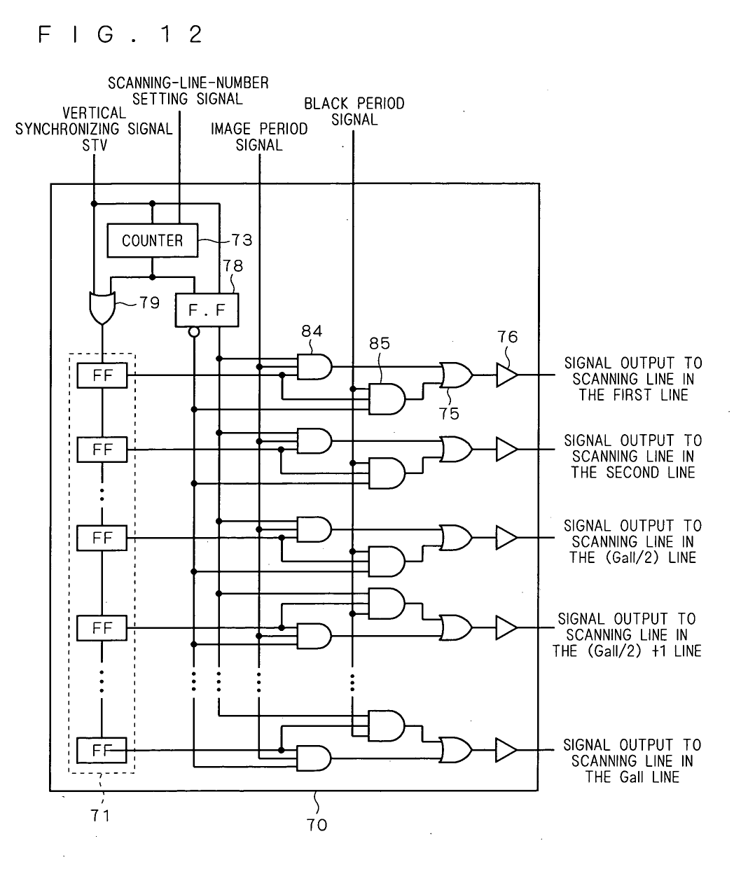

FIG. 12 shows the structure of the scanning line drive circuit 70 according to this embodiment. The counter 73 outputs a timing signal delayed by horizontal scanning periods in accordance with half the total number of scanning lines set by the scanning-line-number setting signal with reference to the vertical synchronizing signal STV. The flip-flop circuit 78 is supplied with the vertical synchronizing signal STV and the timing signal from the counter 73, and outputs the FF signal that is switched between a high state and a low state within half a frame period and the FF inversion signal which is an inversion signal of the FF signal.

The first shift register 71 is supplied with the vertical synchronizing signal STV and the timing signal from the counter 73 via the OR circuit 79. The outputs of the first shift register 71 from the first line through the Gall/2 line (the first half lines) are subjected to an AND operation by the AND circuit 84 together with the FF signal and the image period signal. The outputs of the first shift register 71 through the first half lines are also subjected to an AND operation by the AND circuit 85 together with the FF inversion signal and the black period signal. Then, the outputs of the AND circuits 84 and 85 are subjected to an operation by the OR circuit 75, to be supplied to the scanning line 62 as a scanning line signal via the gate level driver 76.

Meanwhile, the outputs of the first shift register 71 from the (Gall/2)+1 line through the Gall line (the latter half lines) are subjected to an AND operation by the AND circuit 84 together with the FF inversion signal and the image period signal, conversely to the first half lines. The outputs of the first shift register 71 through the latter half lines are also subjected to an AND operation by the AND circuit 85 together with the FF signal and the black period signal. Then, the outputs of the AND circuits 84 and 85 are subjected to an operation by the OR circuit 75, to be supplied to the scanning line 62 as a scanning line signal via the gate level driver 76.

Consequently, a scanning line signal may be produced which includes two pulses of the phase shifted first signal for image writing and second signal for black writing. In short, a liquid crystal display device is attained which is capable of writing an image signal by the first signal and a black signal by the second signal delayed by a prescribed period of time with reference to the first signal within one frame period with respect to all the scanning lines.

As has been described, the scanning line drive circuit 70 according to this embodiment is capable of producing a scanning line signal including two pulses of the phase shifted first and second signals without employing a particular structure. Further, the second shift register 72 may be omitted in the scanning line drive circuit 70 by fixing a 50% duty.

<Modification>

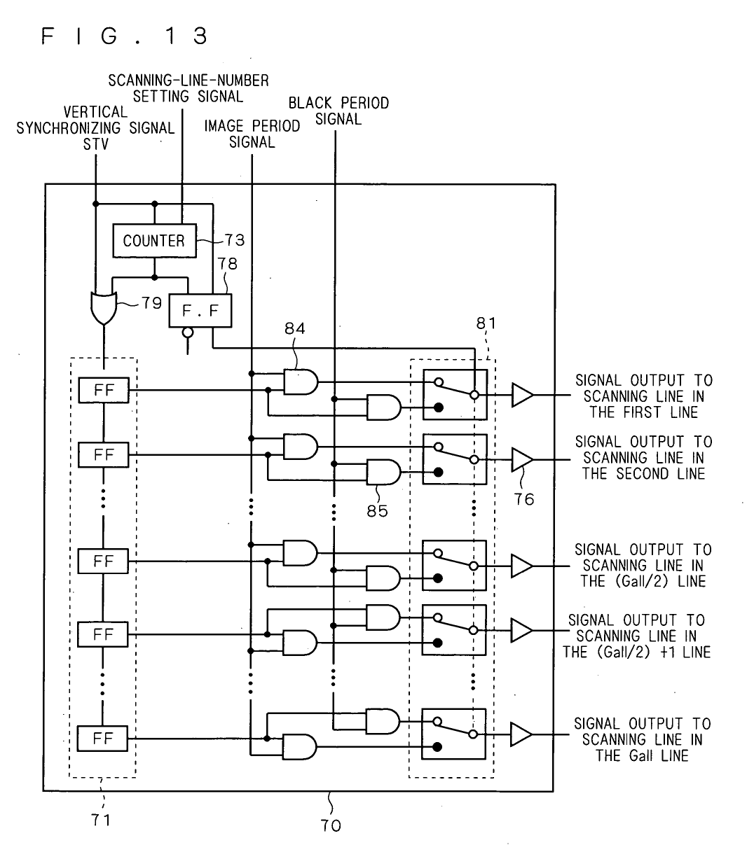

FIG. 13 shows the structure of the scanning line drive circuit 70 according to a modified example of the fifth preferred embodiment. In this scanning line drive circuit 70, unlike the scanning line drive circuit 70 shown in FIG. 12 in which the output of the first shift register 71 is subjected to an AND operation together with the FF signal or FF inversion signal and then the results thereof are subjected to an OR operation, the AND circuits 74 and 80 are controlled by the switch 81 based on the FF signal, thus attaining a simplified structure.

As shown in FIG. 13, in each of the switches 81 in the first half lines, the output of the AND circuit 84 performing an AND operation on the output of the first shift register 71 and the image period signal is connected to the white side terminal, and the output of the AND circuit 85 performing an AND operation on the output of the first shift register 71 and the black period signal is connected to the black side terminal. When the FF signal is in a high state, the white side terminal is turned on, whereby the output of the AND circuit 84 is output as a scanning line signal. When the FF signal is in a low state, the black side terminal is turned on, whereby the output of the AND circuit 85 is output as a scanning line signal.

Likewise, in each of the switches 81 in the latter half lines, the output of the AND circuit 84 performing an AND operation on the output of the first shift register 71 and the image period signal is connected to the black side terminal, and the output of the AND circuit 85 performing an AND operation on the output of the first shift register 71 and the black period signal is connected to the white side terminal. When the FF signal is in a high state, the white side terminal is turned on, whereby the output of the AND circuit 85 is output as a scanning line signal. When the FF signal is in a low state, the black side terminal is turned on, whereby the output of the AND circuit 84 is output as a scanning line signal.

As has been described, the scanning line drive circuit 70 according to this modified example is again capable of producing a scanning line signal including two pulses of the phase shifted first and second signals without employing a particular structure. Further, wiring is reduced, thus attaining a simplified structure.

While the invention has been shown and described in detail, the foregoing description is in all aspects illustrative and not restrictive. It is therefore understood that numerous modifications and variations can be devised without departing from the scope of the invention.

What is claimed is:

1. A liquid crystal display device comprising:
a liquid crystal panel in which pixels are arranged in a matrix;
a scanning line selectively scanning a group of pixels positioned in the same row direction in said liquid crystal panel;
a signal line supplying an image signal to a group of pixels positioned in the same column direction in said liquid crystal panel;
a signal line drive circuit outputting said image signal to said signal line;
an image signal switch connected between said signal line and said signal line drive circuit;
an image-signal-switch control circuit controlling said image signal switch;
a precharge voltage supply circuit supplying a precharge voltage corresponding to a black signal to said signal line;
a precharge switch connected between said signal line and said precharge voltage supply circuit;
a precharge-switch control circuit controlling said precharge switch; and
a scanning line drive circuit supplying a scanning line signal successively to said scanning line in each row, said scanning line signal including a first signal and a second signal within one frame period, wherein
said image signal switch is turned on while said first signal is supplied from said scanning line drive circuit, whereby said image signal is written into said pixels, and only said precharge switch is turned on while said second signal is supplied from said scanning line drive circuit, whereby said precharge voltage is written into said pixels.

2. The liquid crystal display device according to claim 1, wherein said scanning line drive circuit comprises:
a first shift register producing said first signal;
a second shift register producing said second signal;
a counter producing a timing signal to be supplied to said second shift register in order to delay the drive of said second shift register by a prescribed period of time with reference to the drive of said first shift register;
a first logic circuit performing a logical operation on the output of said precharge-switch control circuit and the output of said second shift register;
a second logic circuit performing a logical operation on the output of said first shift register and the output of said first logic circuit; and
a driver circuit supplying the output of said second logic circuit to said scanning line in each row.

3. The liquid crystal display device according to claim 1, wherein said scanning line drive circuit comprises:
a first shift register producing said first signal;
a flip-flop circuit producing said second signal;
a counter producing a timing signal to be supplied to said first shift register and said flip-flop circuit;
a first logic circuit performing a logical operation on the output of said precharge-switch control circuit and the output of said first shift register;
a second logic circuit supplied with the output of said first shift register and the output of said flip-flop circuit;
a third logic circuit performing a logical operation on the output of said first logic circuit and the output of said second logic circuit; and
a driver circuit supplying the output of said third logic circuit to said scanning line in each row, wherein
said first shift register and said flip-flop circuit are supplied with a vertical synchronizing signal and said timing signal delayed by a prescribed period of time corresponding to half the total number of scanning lines with reference to said vertical synchronizing signal,
said flip-flop circuit supplies an output to said second logic circuit provided on said scanning line in each row in the first half lines and to said first logic circuit provided on said scanning line in each row in the latter half lines, and supplies an inverted output to said second logic circuit provided on said scanning line in each row in the latter half lines and to said first logic circuit provided on said scanning line in each row in the first half lines.

4. The liquid crystal display device according to claim 1, wherein said scanning line drive circuit comprises:
a first shift register producing said first signal;
a flip-flop circuit;
a counter producing a timing signal to be supplied to said first shift register and said flip-flop circuit;
a first logic circuit performing a logical operation on the output of said precharge-switch control circuit and the output of said first shift register;
a switch switching between the output of said first shift register and the output of said first logic circuit based on the output of said flip-flop circuit; and
a driver circuit supplying the output of said switch to said scanning line in each row, wherein
said first shift register and said flip-flop circuit are supplied with a vertical synchronizing signal and said timing signal delayed by a prescribed period of time corresponding to half the total number of scanning lines with reference to said vertical synchronizing signal,
said flip-flop circuit supplies an output to said switch provided on said scanning line in each row in the first half lines, and supplies an inverted output to said switch provided on said scanning line in each row in the latter half lines.

5. A liquid crystal display device comprising:
a liquid crystal panel in which pixels are arranged in a matrix;
a scanning line selectively scanning a group of pixels positioned in the same row direction in said liquid crystal panel;
a signal line supplying an image signal to a group of pixels positioned in the same column direction in said liquid crystal panel;
a signal line drive circuit outputting said image signal to said signal line;
a scanning line drive circuit supplying a scanning line signal successively to said scanning line in each row, said scanning line signal including a first signal and a second signal within one frame period; and
a gate array supplying said image signal divided into image display signal and black signal within a horizontal scanning period to said signal line drive circuit, and supplying an image period control signal controlling the timing of displaying said image display signal and a black period control signal controlling the timing of displaying said black signal within a horizontal scanning period to said scanning line drive circuit,
said scanning line drive circuit comprising:
a first shift register producing said first signal for writing said image display signal into said pixels;
a second shift register producing said second signal for writing said black signal into said pixels;
a counter producing a timing signal to be supplied to said second shift register in order to delay the drive of said second shift register by a prescribed period of time with reference to the drive of said first shift register;
a first logic circuit performing a logical operation on said image period control signal and the output of said first shift register;
a second logic circuit performing a logical operation on said black period control signal and the output of said second shift register;
a third logic circuit performing a logical operation on the output of said first logic circuit and the output of said second logic circuit; and
a driver circuit supplying the output of said third logic circuit to said scanning line in each row.

6. A liquid crystal display device comprising:
a liquid crystal panel in which pixels are arranged in a matrix;
a scanning line selectively scanning a group of pixels positioned in the same row direction in said liquid crystal panel;
a signal line supplying an image signal to a group of pixels positioned in the same column direction in said liquid crystal panel;
a signal line drive circuit outputting said image signal to said signal line;
a scanning line drive circuit supplying a scanning line signal successively to said scanning line in each row, said scanning line signal including a first signal and a second signal within one frame period; and
a gate array supplying said image signal divided into image display signal and black signal within a horizontal scanning period to said signal line drive circuit, and supplying an image period control signal controlling the timing of displaying said image display signal and a black period control signal controlling the timing of displaying said black signal within a horizontal scanning period to said scanning line drive circuit, said scanning line drive circuit comprising:
a first shift register producing said first signal for writing said image display signal into said pixels;
a flip-flop circuit producing said second signal for writing said black signal into said pixels;
a counter producing a timing signal to be supplied to said first shift register and said flip-flop circuit;
a first logic circuit performing a logical operation on said image period control signal and the output of said first shift register;
a second logic circuit performing a logical operation on said black period control signal and the output of said first shift register;
a third logic circuit performing a logical operation on the output of said first logic circuit and the output of said second logic circuit; and
a driver circuit supplying the output of said third logic circuit to said scanning line in each row, wherein
said first shift register and said flip-flop circuit are supplied with a vertical synchronizing signal and said timing signal delayed by a prescribed period of time corresponding to half the total number of scanning lines with reference to said vertical synchronizing signal,
said flip-flop circuit supplies an output to said first logic circuit provided on said scanning line in each row in the first half lines and to said second logic circuit provided on said scanning line in each row in the latter half lines, and supplies an inverted output to said second logic circuit provided on said scanning line in each row in the latter half lines and to said first logic circuit provided on said scanning line in each row in the first half lines.

7. A liquid crystal display device comprising:
a liquid crystal panel in which pixels are arranged in a matrix;
a scanning line selectively scanning a group of pixels positioned in the same row direction in said liquid crystal panel;
a signal line supplying an image signal to a group of pixels positioned in the same column direction in said liquid crystal panel;
a signal line drive circuit outputting said image signal to said signal line;
a scanning line drive circuit supplying a scanning line signal successively to said scanning line in each row, said scanning line signal including a first signal and a second signal within one frame period; and
a gate array supplying said image signal divided into image display signal and black signal within a horizontal scanning period to said signal line drive circuit, and supplying an image period control signal controlling the timing of displaying said image display signal and a black period control signal controlling the timing of displaying said black signal within a horizontal scanning period to said scanning line drive circuit,
said scanning line drive circuit comprising:
a first shift register producing said first signal for writing said image display signal into said pixels;
a flip-flop circuit;
a counter producing a timing signal to be supplied to said first shift register and said flip-flop circuit;
a first logic circuit performing a logical operation on said image period control signal and the output of said first shift register;
a second logic circuit performing a logical operation on said black period control signal and the output of said first shift register;
a switch switching between the output of said first logic circuit and the output of said second logic circuit based on the output of said flip-flop circuit; and
a driver circuit supplying the output of said switch to said scanning line in each row, wherein
said first shift register and said flip-flop circuit are supplied with a vertical synchronizing signal and said timing signal delayed by a prescribed period of time corresponding to half the total number of scanning lines with reference to said vertical synchronizing signal,
said flip-flop circuit supplies an output to said switch provided on said scanning line in each row in the first half lines, and supplies an inverted output to said switch provided on said scanning line in each row in the latter half lines.

8. A driving method of a liquid crystal display device, said liquid crystal display device comprising:
a liquid crystal panel in which pixels are arranged in a matrix;
a scanning line selectively scanning a group of pixels positioned in the same row direction in said liquid crystal panel;
a signal line supplying an image signal to a group of pixels positioned in the same column direction in said liquid crystal panel;
a signal line drive circuit outputting said image signal to said signal line;
an image signal switch connected between said signal line and said signal line drive circuit;
an image-signal-switch control circuit controlling said image signal switch;
a precharge voltage supply circuit supplying a precharge voltage corresponding to a black signal to said signal line;
a precharge switch connected between said signal line and said precharge voltage supply circuit;
a precharge-switch control circuit controlling said precharge switch; and
a scanning line drive circuit supplying a scanning line signal successively to said scanning line in each row, said scanning line signal including a first signal and a second signal within one frame period, wherein
said driving method comprises the steps of:
writing said image signal into said pixels during a period over which said first signal is supplied from said scanning line drive circuit and said image signal switch is turned on; and
writing said precharge voltage into said pixels during a period over which said second signal is supplied from said scanning line drive circuit and said precharge switch is turned on.
